(19) United States
(12) Patent Application Publication
(10) Pub. No.: US 2021/0207967 A1
(43) Pub. Date: Jul. 8, 2021

(54) SHARING VEHICLE ACCESS BY USING MOBILE DEVICE MESSAGING

(71) Applicant: VOXX INTERNATIONAL CORPORATION, Hauppauge, NY (US)

(72) Inventors: Robert Andre LaCroix, Lachine (CA); Geoff Weathersby, Solana Beach, CA (US); David Meunier, Montreal (CA)

(73) Assignee: VOXX INTERNATIONAL CORPORATION, Hauppauge, NY (US)

(21) Appl. No.: 17/141,221

(22) Filed: Jan. 4, 2021

Related U.S. Application Data
(60) Provisional application No. 62/957,285, filed on Jan. 5, 2020.

(51) Int. Cl. G01C 21/34; G07C 9/00; H04W 64/00; H04W 4/14

(52) U.S. Cl. CPC G01C 21/3438; G07C 9/00309; G07C 2009/00365; H04W 4/14; H04W 64/003

(57) ABSTRACT

In selected embodiments, a vehicle control system (VCS) is coupled to a vehicle computer and configured to present selectively appearance of a presence in the vehicle of a smartkey, e.g., by energizing/de-energizing the smartkey. The VCS communicates with a remote vehicle control platform (VCP) configured to direct the VCS and send/receive SMS messages. An authorized user of the vehicle sends from a smartphone an SMS to the VCP, identifying the vehicle and a smartphone of another person with whom the authorized user wishes to share the vehicle. The VCP sends an SMS to the other person's smartphone, notifying the other person of the vehicle's availability. The second person replies to the VCP, requesting vehicle access. The VCP receives the reply SMS, validates the other person's smartphone, and signals the VCS to grant vehicle access. The VCS unlocks the vehicle, and energizes the smartkey, rendering the vehicle accessible.

### CROSS-REFERENCE TO RELATED APPLICATIONS

This application claims priority to U.S. Provisional Patent Application Ser. No. 62/957,285, entitled SHARING VEHICLE ACCESS BY USING MOBILE DEVICE-TO-MOBILE DEVICE MESSAGING, filed Jan. 5, 2020, which is hereby incorporated by reference in its entirety as if fully set forth herein, including Specification, Figures. Claims, and all other matter. This application is also related to U.S. patent application Ser. No. 16/529,754, entitled VEHICLE CONTROL SYSTEM AND MOBILE DEVICE USED AS VEHICLE KEY FOB, Robert Andre LaCroix et al., inventors, filed Aug. 1, 2019, now U.S. Pat. No. 10,857,977; U.S. patent application Ser. No. 14/459,036, entitled SMARTPHONE BASED PASSIVE KEYLESS ENTRY SYSTEM, Michael S. Simmons inventor, filed on Aug. 13, 2014, U.S. Patent Application Publication No. 2015/0048927; and U.S. patent application Ser. No. 16/401,704, entitled MULTI-SENSOR PASSIVE KEYLESS FUNCTIONALITY, Aravind Warrior et al., inventors, filed on May 2, 2019, U.S. Patent Application Publication No. 2020/0349781. Each of the above-identified patent documents is hereby incorporated by reference in its entirety as if fully set forth herein, including Specification, Figures, Claims, and all other matter.

### FIELD OF THE DISCLOSURE

This disclosure relates generally to the field of vehicular and other security, access, convenience, monitoring, and control products.

### BACKGROUND

A vehicle control system (“VCS”) may be an OEM or an aftermarket electronic system installed in a vehicle for monitoring, security, and users' convenience and entertainment, as well as for other reasons. The functionality provided by such systems may include remote start capability, passive keyless entry, passive locking, and other security, convenience, entertainment, and monitoring features.

A need in the art exists for improved techniques for providing access to VCS-equipped vehicles without transferring a key, key fob, or analogous access device to another user of the vehicle. A need in the art exists for improved techniques for providing temporary and/or limited access to such vehicles, to the various features of such vehicles and their VCS's, and to various compartments of such vehicles. Other needs in the art will occur to a person skilled in the art after careful perusal of this disclosure (including any documents incorporated by reference), claims, figures, and all other matter filed together with this disclosure.

### SUMMARY

This document describes embodiments, variants, implementations, and examples of novel systems, methods, and articles of manufacture for addressing one or more of the needs identified above, and/or other needs. Selected embodiments described in this document include methods, apparatus, and articles of manufacture that enable improved techniques of sharing vehicles through sending and receiving mobile device messages, such as short message service (SMS) smartphone messages.

In embodiments, an apparatus includes a vehicle control system configured to couple to a computer of a vehicle via a vehicle bus of the vehicle and to control locking and unlocking of the vehicle. The vehicle control system includes one or more VCS processors, memory coupled to the one or more VCS processors and storing VCS software executable by the one or more VCS processors, a first short range radio frequency (RF) VCS transceiver coupled to the one or more VCS processors, and a smartkey power control module (SPCM) configured to provide to a smartkey of the vehicle electrical power selectively under control of the one or more VCS processors, thereby selectively allowing and preventing operation of smartkey-enabled features of the vehicle. The apparatus also includes a cloud-based vehicle control platform (VCP) configured to: send and receive Short Message Service (SMS) messages and control operation of the VCS; receive a first message from a first smartphone of an authorized user of the vehicle, the first message comprising identification of a second smartphone of a second user with whom the first user wishes to share the vehicle; in response to the first message, send a second message to the second smartphone, the second message informing the second user of availability of the vehicle for sharing; receive a third message from the second smartphone, the third message requesting access to the vehicle; validate the third message as coming from the second smartphone; and in response to the third message, send a signal the VCS to grant access to the vehicle.

In embodiments, a method of sharing vehicles includes receiving by a cloud-based system a first message from a first mobile device of an authorized user of a vehicle. The first message includes identification of a second mobile device of a second user. The method also includes sending a second message from the cloud-based system to the second mobile device, in response to the first message. The second message includes a welcome and information regarding availability of the vehicle for sharing. The method additionally includes receiving a third message by the cloud-based system from the second mobile device. The third message includes a request by the second user to access the vehicle. The method further includes validating the third message as coming from the second mobile device and, in response to successful validation of the third message, sending a grant access signal from the cloud-based system to a Vehicle Control System (VCS) installed in the vehicle. The grant access signal causes the VCS to allow access to the vehicle.

In embodiments, an article of manufacture includes a non-volatile machine-readable storage medium with program code stored in the storage medium. When the program code is executed by a cloud-based computing system, it causes the cloud-based computing system to receive a first message from a first mobile device of an authorized user of a vehicle. The first message includes an identification of a second mobile device of a second user. The program code also causes the cloud-based computing system to send a second message to the second mobile device in response to the first message. The second message includes a welcome and information regarding availability of the vehicle for sharing. The program code additionally causes the cloud-based computing system to receive a third message from the second mobile device. The third message requests access to the vehicle. The program code further causes the cloud-based computing system to validate the third message as coming from the second mobile device, and in response to successful validation of the third message, to send a grant access signal to a Vehicle Control System (VCS) installed in the vehicle. The grant access signal causes the VCS to allow access to the vehicle.

In embodiments, an apparatus for enabling sharing of vehicles includes a vehicle control platform (VCP) computing system coupled to a wide area network. The VCP is configured to receive a first message from a first mobile dev ice of an authorized user of a vehicle. The first message includes an identification of a second mobile device of a second user. The VCP is also configured to send a second message to the second mobile device in response to the first message. The second message includes a welcome and information regarding availability of the vehicle for sharing. The VCP is additionally configured to receive a third message from the second mobile device. The third message includes a request to access the vehicle. The VCP is further configured to validate the third message as coming from the second mobile device and send a grant access signal to a Vehicle Control System (VCS) installed in the vehicle in response to successful validation of the third message. The grant access signal causes the VCS to allow access to the vehicle.

Various features and aspects will be better understood with reference to the following description, drawings, and claims.

### BRIEF DESCRIPTION OF THE FIGURES

FIG. 1 illustrates selected components of a Vehicle Control System, configured in accordance with selected aspects disclosed in this document;

FIG. 2 illustrates selected blocks of a system configured to enable message-based vehicle sharing, in accordance with selected aspects disclosed in this document;

FIG. 3 illustrates selected components of a cloud-based system for sharing one or more vehicles, configured in accordance with selected aspects disclosed in this document;

FIG. 4 illustrates selected steps of a vehicle sharing process, in accordance with selected aspects disclosed in this document;

FIG. 5 illustrates selected steps of a process for terminating the sharing of vehicles, in accordance with selected aspects disclosed in this document; and

FIG. 6 illustrates selected steps of a process for initiating and terminating vehicle sharing, in accordance with selected aspects disclosed in this document.

### DETAILED DESCRIPTION

The words “embodiment,” “variant,” “example,” “implementation,” and similar words and expressions as used in this document refer to a particular apparatus, process, or article of manufacture, and not necessarily to the same apparatus, process, or article of manufacture. Thus, “one embodiment” (or a similar word/expression) used in one place or context may refer to a particular apparatus, process, or article of manufacture; the same or a similar expression in a different place or context may refer to a different apparatus, process, or article of manufacture. The expression “alternative embodiment” and similar words and phrases may be used to indicate one of a number of different possible embodiments, variants, examples, or implementations. The number of possible embodiments, variants, examples, or implementations is not necessarily limited to two or any other quantity. Characterization of an item as “exemplary” means that the item is used as an example. Such characterization does not necessarily mean that the embodiment, variant, example, or implementation is a preferred one; the embodiment, variant, example, or implementation may but need not be a currently-preferred embodiment variant, example, or implementation. All embodiments, variants, examples, and implementations are described for illustration purposes and are not necessarily strictly limiting.

The words “couple,” “connect,” and similar words/expressions/phrases with their inflectional morphemes, do not necessarily import an immediate or direct connection, but in addition to direct connections include within their meaning connections through mediate elements.

The expression “processing logic” should be understood as selected steps/decision blocks and/or hardware/software/firmware for implementing the selected steps/decision blocks. “Decision block” means a step in which a decision is made based on some condition, and subsequent process flow is selected based on whether the condition is met or not met.

A vehicle control system (VCS) may be an aftermarket or an OEM system installed in a vehicle to provide convenience, security, and monitoring features, such as security/alarm system functionality; passive keyless entry (“PKE”) and automatic passive action (“APA”) functionalities, including door unlocking and/or opening in response to a person carrying a key or a key fob of the vehicle touching or moving door/hatch handles, door locking and/or closing in response to the person carrying the key/key fob moving away from the vehicle; remote engine start; short-range radio frequency communications (Bluetooth® and other RF communication systems having similar range) with portable devices such as smartphones, smartwatches, tablets, smart implants, and still other devices; and similar functions. A VCS may be such as (or similar to, or having selected components of) the vehicle control systems described in the above-identified and incorporated by reference patent documents; and also in U.S. Pat. No. 10,249,182 entitled REMOTE VEHICLE SYSTEM CONFIGURATION, CONTROL, AND TELEMATICS, James S. Turner first-named inventor, which is incorporated herein by reference for all purposes, including specification, abstract, figures, claims, and all other matter.

A VCS installed in a vehicle may be connected to the Controller Area Network bus (“CAN bus”) of the vehicle, and interface/communicate with the vehicle's electronics/computer via the CAN bus. The VCS may also sense CAN bus communications between and among the vehicle's electronic components. Another type of bus interconnecting the vehicle's electronics may take place of the CAN bus, and the vehicle's VCS may similarly interface/communicate with the vehicle's electronics/computer via such bus, as well as sense communications of the vehicle's electronic components on such bus.

A “mobile device” (or simply a “mobile”) and “portable device” are used interchangeably, to signify smartphones, smartwatches, tablets, smart implants, portable computers, and similar portable devices. A mobile device typically includes a processing module (such as microprocessor(s), microcontroller(s), other programmable devices, and their memories and other supporting electronic components); a user I/O interface (such as a display/keyboard/touch-sensitive display); one or more transceivers (such as cellular transceivers, WiFi transceivers, Bluetooth® and other relatively short-range radio frequency transceivers); and other components.

A smart key and smart key fob may be referred to as “smartkey.” In typical use, the vehicle (vehicle computer, vehicle electronics) may send a signal (a “challenge”) to a smartkey, to determine whether a smartkey authorized to access/operate the vehicle is present inside the vehicle or in the immediate vicinity of the vehicle; when the smartkey responds (by sending a “challenge response”), the vehicle (vehicle computer/electronics) may allow engine start and/or operation of all or of selected convenience and security features, such as locking/unlocking the vehicle and the vehicle's various compartments (trunk, glove compartment, hood, etc.), and arming/disarming the vehicle's security system. The smartkey's response may be static or, more commonly, a result of a dynamic computation, e.g., to prevent smartkey spoofing. Some VCSs described in this and the incorporated documents may be configured to sense challenges, generate appropriate challenge responses (in the place of the smartkey), and send the challenge responses to the vehicle, thus simulating a smartkey's presence.

Some definitions have been explicitly provided above. Other and further explicit and implicit definitions and clarifications of definitions may be found throughout this document.

In embodiments, the VCS and or the smartkey of the vehicle are configured to make it appear to the vehicle's electronics/computer that the functionality associated with the smartkey's presence should be enabled. For example, the smartkey may be placed in the vehicle, and preferably secured so that it cannot be readily found and/or removed or tampered with. The smartkey may be secured, for example, in the enclosure of the VCS. The vehicle's electronics computer would then be able to sense the presence of the smartkey in the vehicle and allow engine start and/or operation of convenience, security, and/or other features that require an authorized smartkey of the vehicle to be inside or in the immediate vicinity of the vehicle (“smartkey-enabled features”). But the VCS connected to the vehicle's CAN bus (or another analogous type of a bus interconnecting electronics of the vehicle) may be configured selectively to prevent engine start and/or operation of the smartkey-enabled features. In this way, the security of the vehicle may be preserved despite the presence of the smartkey in the vehicle, because the VCS can selectively (under control of the VCS processor, through the bus) enable and prevent engine start and operation of the other smartkey-enabled features.

In embodiments, the VCS is configured to simulate selectively the presence of the smartkey in or near the vehicle, by receiving from the vehicle's electronics the smartkey challenges, and generating the appropriate challenge responses, to make it appear to the vehicle's computer that the smartkey is present in or near the vehicle. For example, the VCS can receive the challenges from the CAN or analogous bus, and return appropriate challenge responses, also through the bus. In another example, the VCS may be connected through a transceiver to the antenna that the vehicle's computer/electronics use to transmit the smartkey challenges and receive challenge responses. The VCS may interpret the challenges actually sent by the vehicle electronics to the smartkey, unlike sensing the challenges through the bus. (The “antenna” here includes the wire connected to the antenna proper.) The VCS may then selectively (under control of the VCS processor) generate appropriate challenge responses to simulate the presence of the smartkey in/near the vehicle, and drive the antenna with these challenge responses. As has already been mentioned, the challenges and/or the responses may be static or dynamic; a dynamic response varies from time-to-time, location-to-location, challenge-to-challenge, and/or otherwise; the VCS and/or the mobile device of a user have (or can obtain) information for determining/computing an appropriate response to a challenge, for example, in the same way as the vehicle's smartkey would.

In embodiments, the VCS includes a smartkey power control module for the smartkey of the vehicle. The smartkey receives the electrical power for its operation when the VCS (under control of the VCS processor) determines that the operation of the smartkey-enabled features is allowed and/or required, and configures the smartkey power control module so that the smart key is energized. The smartkey power control module may be an electrically-operated switch such as an electromechanical or a solid state relay; it may be placed, for example, in series with the battery contacts (power inputs) of the smartkey. When the smartkey power control module, under control of the VCS processor, turns on the power to the smartkey in the vehicle, the vehicle electronics sense the smartkey's presence and allow operation of the smartkey-enabled features. The smartkey may be, for example, secured to the vehicle and/or be placed inside the enclosure of the VCS or one of the modules of the VCS, to make unauthorized removal difficult. The VCS is configured to turn the power to the smartkey on when needed to operate any of the smartkey-enabled features, such as the panic command, engine start, door lock/unlock, security features enable/disable and arm/disarm, and others.

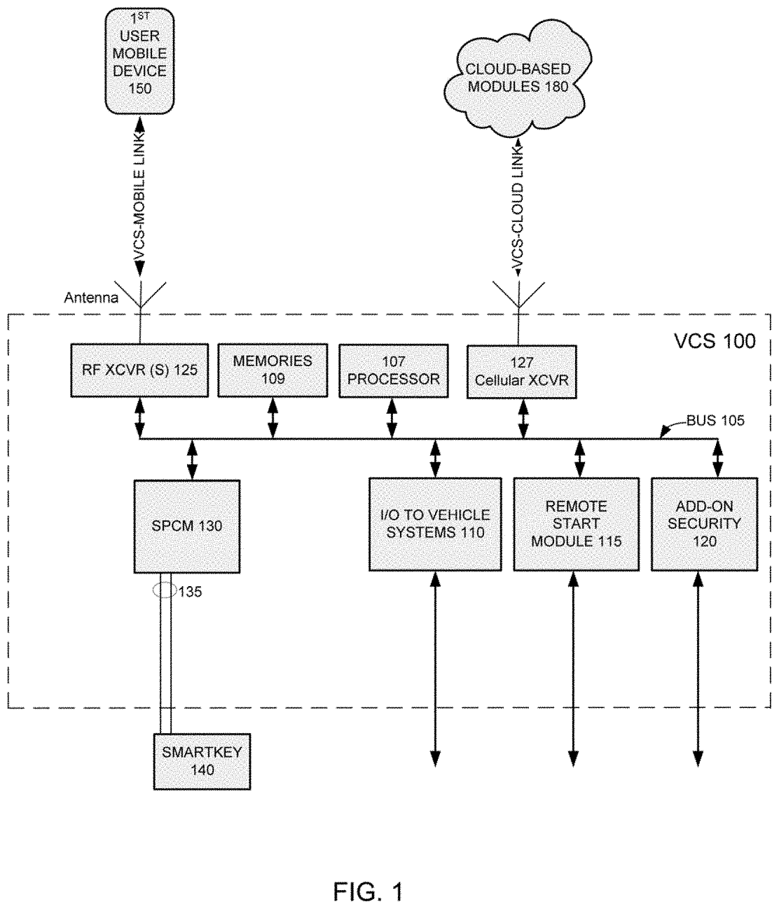

FIG. 1 illustrates selected components of an exemplary Vehicle Control System 100 that includes a smartkey power control module through which the VCS selectively energizes and de-energizes a smartkey of the vehicle in which the VCS is installed, and thus enables and disables the smartkey-enabled features of the vehicle, as is described above and in the incorporated documents.

The VCS 100 includes a bus 105, a processing module 107, a memory/storage module 109, an interface or interfaces 110 to vehicle systems (e.g., door locks, power windows, entertainment system, alarm, and others), a remote start module 115, an add-on security module 120, a relatively short range RF communication interface/transceiver(s) 125 to external devices, a smartkey power control module (SPCM) 130 configured to provide selectively electrical power to a smartkey 140, and additional RF transceiver(s) 127 for communicating with cloud-based hardware/software modules 180. The smartkey 140 may be considered port of the VCS 100, or a separate component, and may be placed inside the enclosure of the VCS 100 or outside the enclosure.

The bus 105 may be as a processor-based system bus that provides communication/networking capability between and among the components of the VCS 100. The processing module 107 may include, for example, a microprocessor/microcontroller and supporting electronics. The memory/storage module(s) 109 can store instructions executable by the processing module 107; the memory/storage module(s) 109 may include one or more memories of same or different types, such as ROMs, PROMs, EPROMS, EEPROMS, flash memories, optical disks, magnetic storage devices, and/or other memories-storage. The memory/storage module(s) 109 may also include volatile memory module(s) such as DRAM modules, which may be battery backed.

The interface or interfaces 110 may connect to an engine computer (engine control module or ECM); a transmission computer (transmission control module or TCM); built-in vehicle firmware; built-in security features of the vehicle; a telematics module; and data storage for data that includes the vehicle's usage and performance data, such as OBD II data. The interface 110 may be a CAN bus interface.

The remote start module 115 allows starting of the vehicle by the VCS 100, in response to appropriate commands, for example, remote start commands received from a user mobile device 150. The remote start module 115 may also interact with the vehicle control modules through the interfaces 110 accessible to the remote start module 115 through the bus 105.

The add-on security module 120 may connect to and monitor various sensors (e.g., shock/vibration, proximity, intrusion, door or other entry point touch sensors/controls that indicate when the user is trying to open the entry point for access to the vehicle), and may operate and/or sense state of and/or control various convenience features (e.g., power windows, power locks, power seats, steering wheel telescoping and tilt positions, audio system presets and other audio system controls).

The relatively short range RF communication transceiver(s) 125 may include, for example, a Bluetooth® interface. The transceiver(s) 125 may also be or include other types of RF interfaces. Moreover, multiple relatively short range RF transceivers may be included. Thus, a first transceiver and a second transceiver may be included, the first transceiver 125 having a shorter communication range than the second transceiver. For example, the transmit power of the first transceiver 125 may be less than the transmit power of the second transceiver 125 by a factor of 2-20, with the two transceivers 125 being of the same type (such as Bluetooth®) or of different types. The first transceiver 125 may be, for example, a Bluetooth® Low Energy transceiver, while the second transceiver 125 may be a non-LE Bluetooth® transceiver.

The transceiver(s) 127 may include a cellular transceiver providing to the VCS 100 access to a cellular telephone/data network and other networks, such as the Internet and the cloud-based modules 180.

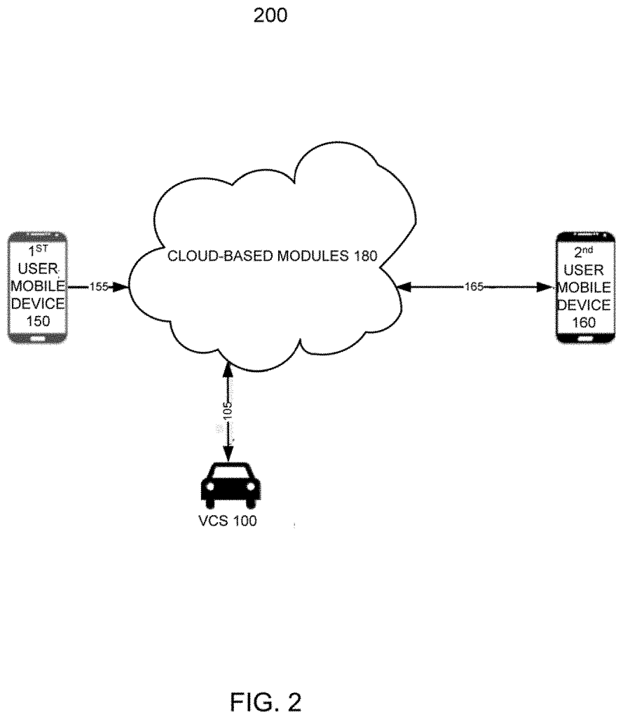

FIG. 2 illustrates selected blocks of a system 200 configured to enable message-based (such as SMS-based) vehicle sharing. The system 200 includes the VCS 100 installed in a vehicle; the cloud-based hardware/software modules 180; the user mobile device 150 associated with a first user (e.g., a smartphone/tablet/smartwatch/smart implant belonging to the first user, in possession of the first user, carried by the first user, and/or operated by the first user); and a second user mobile device 160 associated with a second user (e.g., a smartphone/tablet/smartwatch/smart implant belonging to the second user, in possession of the second user, carried by the second user, and/or operated by the second user). Here, the first user mobile device 150 may be loaded with a special app that enables the first user to grant vehicle access to other users, such as the second user with the second user mobile device 160. (The app may be referred to as a SmartAssetSharing app.) The second user mobile device 160 may also have a special app to enable/facilitate vehicle sharing in some variants. In other variants, however, the second user mobile device 160 does not have such special app, and the first user may be enabled to share the vehicle with other users without requiring the other users to have made previous arrangements, such as loading the other users' mobile devices with a special app such as the SmartAssetSharing app. Note also that the first user may be able to share multiple vehicles with one or more second users. In the system 200, a link 155 connects the first user device 150 to the cloud and the cloud-based modules 180; a link 165 connects the second user device 160 to the cloud and the cloud-based modules 180; and a link 105 connects the VCS 100 to the cloud and the cloud-based modules 180.

Although the link 155 is shown as a unidirectional link, in variants it is bidirectional, allowing the cloud-based modules 180 to send messages/information to the first user mobile device 150. The link 105 is shown as a bidirectional link, but in variants it may be a unidirectional link, from the cloud-based modules 180 to the VCS 100, allowing the cloud-based modules 180 to control and send information to the VCS 100. Note, however, that additional links may be present, for example, between the mobile devices 150/160, and between the mobile device 150 and the VCS 100. (The listing of links is not exclusive.)

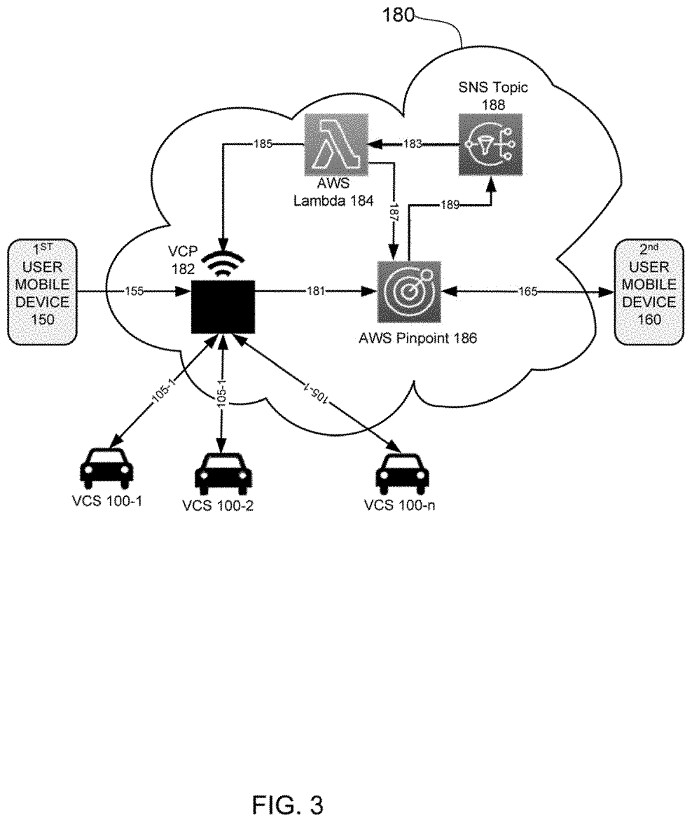

FIG. 3 illustrates selected modules 180 in an embodiment implemented using Amazon Web Services (“AWS”). To generalize to some extent, the system shown in this Figure allows sharing of multiple vehicles, each with a VCS (VCS 100-1 . . . VCS 100-n).

Here, the cloud-based modules 180 include a Vehicle Control Platform (VCP) 182, which may include a set of cloud services used to relay data and commands to/from vehicles, and manage vehicle accounts, as well as other services functions. In embodiments, the VCP 182 may expose application programming interlaces (“API”s) to grant and revoke sharing privileges; expose the APIs to send commands to vehicles; validate authority of a user invoking the APIs; and invoke an AWS Pinpoint 186 (discussed below) to send an initial welcome message and/or other messages to the first user and other users of the system.

The cloud-based modules 180 may also include AWS Lambda 184, which can execute functions provided by clients as a service (“Function as a Service” or “FaaS”). In embodiments, AWS Lambda 184 may receive an SMS payload, validate command(s), retrieve an asset such as a vehicle shared with a sender's SMS number, validate time period for which the asset is shared; access APIs of the VCP 182 to send command(s) to the vehicle, and reply to a sender with SMS messages indicating, e.g., success, failure, or access denied.

The cloud-based modules 180 may additionally include the AWS Pinpoint 186, which module(s) is/are capable of sending personalized, timely, and relevant communications through multiple channels. In embodiments, AWS Pinpoint 186 may provide dedicated long codes (e.g., SMS numbers), send SMS messages to end users originating from dedicated long codes, receive SMS messages sent from end users to dedicated long codes, and invoke an SNS Topic 188 when an SMS message is received.

The SNS Topic 188 of the cloud-based modules 180 is an AWS simple notification service. In embodiments, the SNS Topic 188 notifies the AWS Lambda 184 of SMS message(s) from the AWS Pinpoint 186.

As is illustrated in FIG. 3. the links 105-1 . . . 105-n connect SMS portals of the respective VCSs 100-1 . . . 100-n to the VCP 182, the link 155 connects the first user mobile device 150 to the VCP 182, and the link 165 connects the second user mobile device 160 to the AWS Pinpoint 186. The links internal to the cloud-based modules 180 include a link 181 from the VCP 182 to the AWS Pinpoint 186, a link 183 from the SNS Topic 188 to the AWS Lambda 184, a link 185 from the AWS Lambda 184 to the VCP 182, a link 187 from the AWS lambda 184 to the AWS Pinpoint 186, and a link 189 from the AWS Pinpoint 186 to the SNS Topic 188; each of these links may be bidirectional in some variants.

Note that AWS is used for illustration, and other services and proprietary systems may be used. Similarly, the specific architecture of the cloud-based modules in FIG. 3 may be replaced by different architectures configured to provide identical or analogous functionality.

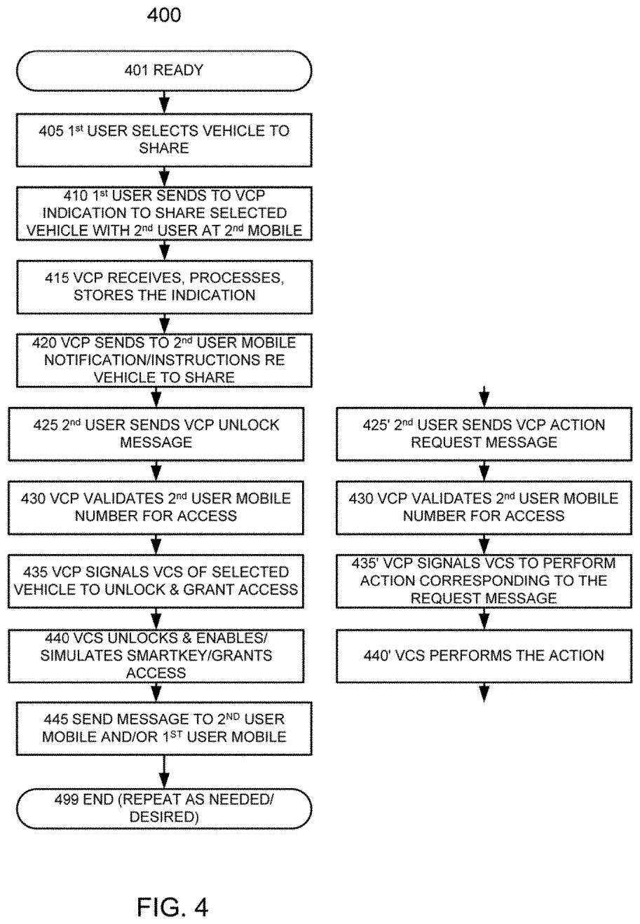

In operation, the cloud-based modules 180 and the mobile device 150 executing the SmartAssetSharing app may be configured to enable vehicle sharing through the use of SMS or other messages. FIG. 4 illustrates selected steps of a process 400 for sharing a vehicle in which a VCS 100 is installed. For the purposes of this example, the first user at the mobile device 150 has the ability/authorization to control, operate, and share multiple vehicles, and proceeds to share with the second user at the mobile device 160 one of these vehicles, say the vehicle with the VCS 100-1.

At flow point 401, the first user mobile device 150 (with the SmartAssetSharing app installed) and the second user mobile device 160 are powered up and ready for operation, and the cloud-based modules 180 have been properly configured and are also ready for operation. Further, the VCS 100 is installed, properly configured, and powered up at this point.

In step 405, the app on the first user mobile device 150 is activated (e.g., by tapping the SmartAssetSharing app icon) and presents to the first user a menu with a selection of vehicles for sharing. As noted above, the first user mobile device 150 may enable access/sharing of more than one vehicle, though this is not a requirement. From the menu, the first user selects a vehicle for sharing (e.g., by tapping in appropriate places on the screen of the user's mobile, as may be the case with other selections and inputs made by the first and second users). In response to the vehicle selection, the app may present to the first user one or more sharing parameters, and the first user may choose value(s) for the parameter(s) and input the value(s) into the app. For example, the first user may specify sharing start time, sharing end time, sharing duration, and the phone number of the second user mobile device 160. As will be seen, the VCP 182 may use the number of the second user mobile device 160 for messaging and identification/Verification of the permission for the second user to use the selected vehicle.

In step 410, the first user mobile device 150 transmits to the VCP 182 a “sharing indication” message indicating dial the second user at the number of the second user mobile device 160 is authorized to use the vehicle; the message may include any of the parameters for sharing, particularly the number of the second user mobile device. (The messages from/to mobile devices described in this document may be SMS or analogous messages.)

In step 415, the VCP 182 receives the sharing indication, stores the sharing indication, and processes it, e.g., extracting the second mobile number and other parameters for sharing.

In step 420, the VCP 182 sends a welcome message to the second user mobile device, which message may also include other data and instructions relating to sharing of the vehicle. For example, the message may include the following text:
[Name of the person at the first mobile device number] has given you full access to the person's [vehicle identifier] from [start date & time] to [end date and time]. Reply with HONK or FLASH to find the vehicle, and UNLOCK to enter the vehicle. Reply with LOCK when leaving the vehicle.

In step 425, the second user at the second user mobile device 160 receives the welcome message and sends a reply to the welcome message, for example, “UNLOCK.”

In step 430, the VCP 182 receives the reply and validates the reply (e.g., verifies the phone number from which the reply was sent). The VCP 182 may do this, for example, by comparing the number of the phone from which the reply was sent to the number in the sharing indication; in embodiments, a password or analogous authentication may also be included in the sharing indication and used for verification of the second user and the second user mobile device 160.

If the validation is successful (e.g., the numbers match, password is correct), in step 435 the VCP 182 sends a message (instruction/command) to the VCS of the selected vehicle, to cause the VCS to unlock the vehicle and grant access to the second user. The VCS may grant access by energizing the smartkey 140 through the SPCM 130.

In step 440, the VCS receives the instruction/command from the VCP 182 and acts upon it, unlocking the vehicle and granting access to the second user at the second user mobile device 160. The VCS may grant access by configuring the SPCM 130 to energize the smart key 140 in the vehicle. The VCS ma also be configured to confirm that the second user mobile device is sufficiently near the selected vehicle, before unlocking the vehicle and granting access.

In step 445, the cloud-based modules 180 may send one or more messages to the first user mobile device 150 and/or the second user mobile device 160, confirming that the requested action (e.g., unlocking, granting access) has been carried out.

The process flow may then terminate at How point 499, to be repeated as needed or desired.

The second user may send to the VCP 182 another reply message, such as FLASH or HONK, and the VCP 182 may then validate the second user mobile device number, signal the VCS to perform an action corresponding to the reply message (e.g., honk the horn/siren, flash headlights). Selected steps of this example are illustrated on the right side of FIG. 4, as steps 425′, 430, 435′, and 440′. In step 425′, the second user at the second user mobile device 160 receives the welcome message and sends a reply to the welcome message specifying a different action (or multiple actions), such as “HONK,” “FLASH” etc. In step 435′, the VCP 182 sends a message (instruction/command) to the VCS of the selected vehicle, to cause the VCS to perform the action(s) specified in the reply message, such as honking the horn, flashing headlights, etc. The VCS receives the instruction/command from the VCP 182 and acts upon it, and performs the action(s), in step 440′. Other steps of this modified process 400 may be identical or analogous to the steps 405-420, 430, and 445 of the main illustration on the left side of FIG. 4.

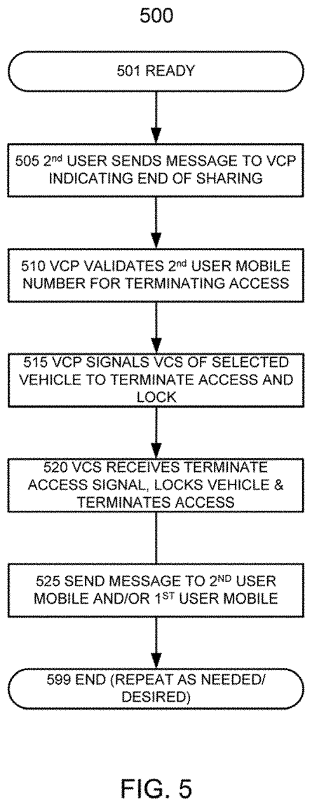

FIG. 5 illustrates selected steps of a process 500 for terminating the sharing of the vehicle in response to a request/notification from the second user mobile device 160.

At flow point 501, the first user mobile device 150 and the second user mobile device 160 are powered up and ready for operation, the cloud-based modules 180 have been properly configured, and sharing of the vehicle has previously been initiated, for example, as described in relation to the process 400.

In step 505, the second user at the second user mobile device 160 sends to the VCP 182 a predetermined message indicating that the second user wishes to terminate sharing, for example, “LOCK.”

In step 510, the VCP 182 validates the second user mobile device number. This may be similar to the step 430 of the process 400. In embodiments where a password or analogous authentication information was included in the sharing indication, the password or information may also or instead be used for verification.

If the validation is successful, in step 515 the VCP 182 sends to the VCS a message to terminate access of the second user (second user mobile device 160) and lock the vehicle (this message may be referred to as a “sharing termination message”).

In step 520, the VCS receives the sharing termination message from the VCP 182, locks the vehicle, and terminates access grant. The access grant may be terminated, for example, by disabling/de-energizing the smartkey in the vehicle, and/or by configuring the VCS not to provide access or perform other functions in response to the VCS sensing proximity of the second user mobile device 160.

In step 525, one or more messages may be sent to the first user mobile device 150 and/or the second user mobile device 160, confirming termination of sharing of the vehicle. The VCP 182 may send these messages.

The process flow may then terminate at flow point 599, to be repeated as needed or desired.

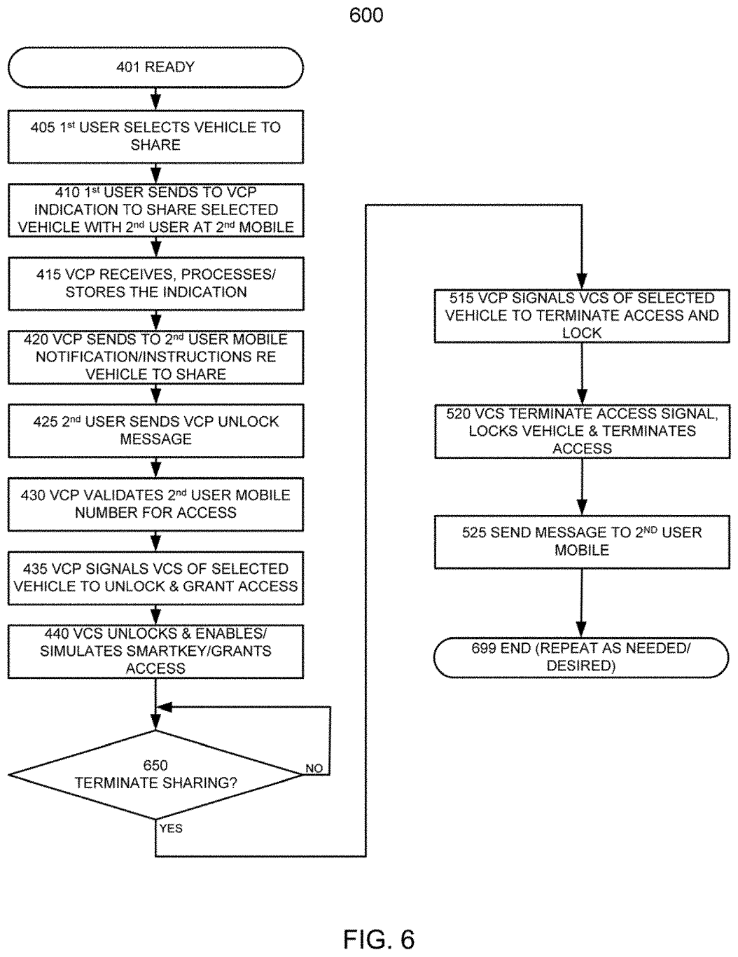

The sharing of the vehicle may also be terminated in response to other events, for example, automatically, when the time/period of sharing (parameters mentioned above) expire, when the first user sends a message to the VCP 182 through the SmartAssetSharing app (making a call to the VCP API, e.g., from the first user mobile device 150 or another authenticated device) to terminate sharing, or in response to some other condition(s) for terminating sharing being met. FIG. 6 illustrates selected steps/decision blocks of a process 600 for sharing a vehicle and then terminating the sharing upon occurrence of some predetermined condition. The flow point 401 and the steps 405-440 have already been described in relation to FIG. 4. From the step 440, process flow proceeds to decision block 650, to test whether the required condition or conditions for terminating sharing has/have been met. If the required condition(s) has/have not been met, the process flow returns to the input to the decision block 650, waiting for the condition(s) to be met. Otherwise, the process flow continues to the steps 515-525, as shown, which steps have been described above in relation to FIG. 5. The process flow may then terminate at flow point 699, to be repeated as needed or desired.

The processes and apparatus for sharing described in this document may be used with vehicles such as cars, boats, planes, golf carts, ATVs, RVs, snowmobiles, and others. The processes and apparatus may also be adapted to enable sharing of other assets, whether movable or not movable, including real estate assets such as dwellings, offices, warehouses, and others.

Not every illustrated/described step and decision block may be required in every embodiment in accordance with the concepts described in this document, while some steps and decision blocks that have not been specifically illustrated may be desirable or necessary in some embodiments in accordance with the concepts. The process steps and decisions may be performed by same and/or separate elements, in conjunction or in parallel, asynchronously or synchronously, in a pipelined manner, or otherwise. There is no particular requirement that the steps and decisions be performed in the same order in which this description lists them and/or the Figures show them, except where a specific order is inherently required, explicitly indicated, or is otherwise made clear from the context. Specific embodiments/variants/examples/implementations, however, use the particular order(s) in which the steps and decisions (if applicable) are shown and/or described. The features (limitations, elements/steps or parts thereof) described and illustrated throughout this document, the attached Figures, and the incorporated documents, may be present individually, or in any combination or permutation, except where the presence or absence of specific features is inherently required, explicitly indicated, or is otherwise made clear from the description and the drawings. This applies whether or not the features appear related to specific embodiments; in other words, features of one described or illustrated embodiment (of this document and of the incorporated documents) may be included in another described or illustrated embodiment.

The instructions (machine executable code) corresponding to the method steps of the disclosed embodiments, variants, examples, and implementations may be embodied directly in hardware, in software, in firmware, or in combinations thereof. A software module may be stored in volatile memory, flash memory, Read Only Memory (ROM), Electrically Programmable ROM (EPROM), Electrically Erasable Programmable ROM (EEPROM), hard disk, a CD-ROM, a DVD-ROM, or other form of non-transitory storage medium. Exemplary storage medium or media may be coupled to one or more processors so that the one or more processors can read information from, and write information to, the storage medium or media. In an alternative, the storage medium or media may be integral to one or mote processors.

This document describes in detail the inventive apparatus, methods, and articles of manufacture for vehicle sharing. This was done for illustration purposes and, therefore, the foregoing description is not necessarily intended to limit the spirit and scope of the invention(s) described. Neither the specific embodiments of the invention(s) as a whole, nor those of its (or their, as the case may be) features necessarily limit the general principles underlying the invention(s). The specific features described herein may be used in some embodiments, but not in others, without departure from the spirit and scope of the invention(s) as set forth herein. Various physical arrangements of components and various step sequences also fall within the intended scope of the invention(s). Many additional modifications are intended in the foregoing disclosure, and it will be appreciated by those of ordinary skill in the pertinent art that in some instances some features will be employed in the absence of a corresponding use of other features. The embodiments described above are illustrative and not necessarily limiting, although they or their selected features may be limiting for some claims. The illustrative examples therefore do not necessarily define the metes and bounds of the invention(s) and the legal protection afforded the invention(s).

What is claimed is:

1. A method of sharing vehicles, the method comprising:
receiving a first message from a first mobile device of an authorized user of a vehicle, the first message comprising identification of a second mobile device of a second user, the step of receiving the first message being performed by a cloud-based system comprising one or more remote servers;
in response to the first message, sending a second message from the cloud-based system to the second mobile device, the second message comprising information regarding availability of the vehicle for sharing;
receiving a third message by the cloud-based system from the second mobile device, the third message requesting access to the vehicle;
validating the third message as coming from the second mobile device; and
in response to successful validation of the third message, sending a grant access signal from the cloud-based system to a Vehicle Control System (VCS) installed in the vehicle, wherein the grant access signal causes the VCS to allow access to the vehicle.

2. The method of claim 1. wherein the first message, the second message, and the third message are Short Message Service (SMS) messages.

3. The method of claim 1, wherein the first message, the second message, and the third message are text messages.

4. The method of claim 3, further comprising:
receiving a fourth message by the cloud-based system from the second mobile device, the fourth message comprising a request to activate a feature of the VCS or of the vehicle;
sending a feature activation signal from the cloud-based system to the VCS, wherein the feature activation signal causes the VCS to activate the feature.

5. The method of claim 4, wherein the step of receiving the fourth message precedes the step of receiving the third message, the method further comprising validating the fourth message as coming from the second mobile device.

6. The method of claim 5, wherein the feature comprises activating at least one of a sound emitting device of the vehicle or of the VCS, and activating a light emitting device of the vehicle.

7. The method of claim 3, wherein:
the identification of the second mobile device comprises telephone number of the second mobile device; and
the step of validating the third message comprises extracting telephone number of sending device from the third message, and comparing the telephone number of the sending device to the telephone number of the second mobile device. 8. The method of claim 1, wherein:
the first message further comprises a password; and
the step of validating the third message comprises sending a request for verification message from the cloud-based system to the second mobile device, receiving by the cloud-based system a message containing a response to the request for verification, and comparing the password to the the response to the verification.

9. The method of claim 3, further comprising:
receiving the grant access signal by the VCS; and
allowing access to the vehicle by the VCS, in response to the grant access signal.

10. The method of claim 9, wherein the step of allowing access to the vehicle comprises unlocking the vehicle.

11. The method of claim 9, wherein the step of allowing access to the vehicle comprises disarming an alarm system installed in the vehicle.

12. The method of claim 9, wherein the step of allowing access to the vehicle comprises enabling at least one smartkey-enabled feature of the vehicle.

13. The method of claim 9, wherein the step of allowing access to the vehicle comprises providing power to a smartkey of the vehicle by the VCS.

14. The method of claim 9, further comprising:
determining whether a required condition for terminating access is satisfied; and
terminating access to the vehicle.

15. The method of claim 14, wherein:
the step of allowing access to the vehicle comprises at least one of unlocking the vehicle and disarming an alarm system installed in the vehicle; and
the step of terminating access to the vehicle comprises at least one of locking the vehicle and arming the alarm system.

16. The method of claim 14, wherein:
the step of allowing access to the vehicle comprises providing power to a smartkey of the vehicle by the VCS; and
the step of terminating access to the vehicle comprises disconnecting power to the smartkey.

17. The method of claim 9, further comprising:
sending the first message from the first mobile device to the cloud-based system.

18. An article of manufacture comprising at least one non-volatile machine-readable storage medium with program code stored in the at least one non-volatile machine-readable storage medium, the program code, when executed by a cloud-based computing system, causes the cloud-based computing system to
receive a first message from a first mobile device of an authorized user of a vehicle, the first message comprising identification of a second mobile device of a second user;
send a second message to the second mobile device in response to the first message, the second message comprising information regarding availability of the vehicle for sharing;
receive a third message from the second mobile device, the third message requesting access to the vehicle;
validate the third message as coming from the second mobile device; and
send a grant access signal to a Vehicle Control System (VCS) installed in the vehicle in response to successful validation of the third message, wherein the grant access signal causes the VCS to allow access to the vehicle.

19. An apparatus for enabling sharing of vehicles, the apparatus comprising a computing system coupled to a wide area network, wherein the computing system is configured to
receive a first message from a first mobile device of an authorized user of a vehicle, the first message comprising identification of a second mobile device of a second user;
send a second message to the second mobile device in response to the first message, the second message comprising information regarding availability of the vehicle for sharing;
receive a third message from the second mobile device, the third message requesting access to the vehicle;
validate the third message as coming from the second mobile device; and
send a grant access signal to a Vehicle Control System (VCS) installed in the vehicle in response to successful validation of the third message, wherein the grant access signal causes the VCS to allow access to the vehicle.

20. The apparatus of claim 19, further comprising:
the VCS, wherein the VCS is configured to couple to a computer of the vehicle via a vehicle bus of the vehicle and to control locking and unlocking of the vehicle, the VCS comprising one or more processors, memory coupled to the one or more processors and storing software executable by the processors, a first radio frequency (RF) transceiver coupled to the one or more processors, and means for selectively allowing and preventing operation of smartkey-enabled features of the vehicle.
